(19) United States
(12) Patent Application Publication
(10) Pub. No.: US 2005/0286512 A1
(43) Pub. Date: Dec. 29, 2005

(54) Flow processing

(76) Inventors: Atul Mahamuni, San Jose, CA (US); Alex Bachmutsky, Sunnyvale, CA (US); Chi Fai Ho, Sunnyvale, CA (US)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/876,774

(22) Filed: Jun. 28, 2004

(51) Int. Cl. H04L 12/28

(52) U.S. Cl. 370/389

(57) ABSTRACT

A method, system, network nodes and computer programs for processing a packet data flow in a packet data network is disclosed. In the invention a conventional <rule, action> pair is broken into a two-step process. The new processing follows, for example, <rule, optional-action, future-action-tag> out-of-box-processing <future-action-tag, egress-action> semantics. An important point is that both the “optional-action” and “egress-action” are decided on the basis of the original rule. The execution of “egress-action” in only delayed till transformed packets are received back at the service-aware network element. Due to the two-step process, the invention allows a creation of IP services even with a third party out-of-box services that completely transform the packets.

### BACKGROUND OF THE INVENTION

1. Field of the Invention

The present invention relates to data communication networks. In particular, the present invention relates to a novel and improved method, system, network elements and computer programs for processing a packet data flow.

2. Description of the Related Art

In packet-switched networks such as the Internet, a router is a device or, in some cases, software in a computer, that determines the next network point to which a packet should be forwarded toward its destination. The router is connected to at least two networks and decides which way to send each information packet based on its current understanding of the state of the networks it is connected to. A router is located at any gateway (where one network meets another), including each point-of-presence on the Internet. A router is often included as part of a network switch.

A router may create or maintain a table of the available routes and their conditions and use this information along with distance and cost algorithms to determine the best route for a given packet. Typically, a packet may travel through a number of network points with routers before arriving at its destination. Routing is a function associated with the Network layer (layer 3) in the standard model of network programming, the Open Systems Interconnection (OSI) model. A layer 3 switch is a switch that can perform routing functions.

New technologies have been developed to improve the inefficiency for the routing of packets. One solution is to apply a so-called flow-based routing solution.

Flow-based routing is based on the principle of recognizing flows, routing the first packet of the flow, dynamically associating a temporary state with it and then switching remaining packets in the flow using the state information. The fact that decisions are made on a flow-by-flow basis for all the flows traversing the router, as opposed to decisions being made on a packet-by-packet basis, represents the key difference between flow-based routing architecture and existing router architectures. The notion of flow is network-dependent. For example, a 5-tuple Internet Protocol (IP) information (including the IP source and destination addresses, Transmission Control Protocol (TCP)/User Datagram Protocol (UDP) source and destination ports and protocol type) may be considered as a flow.

Flow-based routing performs extensive processing on the first packet of a flow, associates that flow with a state and applies the result of this processing to subsequent packets in the flow. The state information is dynamically created and deleted without any explicit signaling and as such is of a soft-state nature. It is managed by monitoring the dynamics of TCP and UDP flows. The first packet of a flow is routed according to overall packet routing rules, in keeping with the flexibility and robustness inherent in IP networks. Remaining packets in the flow, however, are switched based on the stored flow state information, providing the predictability and traceability of connection-oriented technologies.

Flow-based routing technology offers benefits from three major perspectives. First, it provides significant switch-level benefits, allowing the emergence of new high-speed packet processing with extensive parallelism and highly scalable switching fabric architectures with innovative switch-level resource management schemes. Second, it has a number of network-level benefits in terms of routing efficiency, load balancing and, more importantly, network-level QoS. Third, it enables new service models in the Internet that permit the convergence of multiple services over the Internet and the emergence of new IP-based services applications with stringent Quality of Service (QoS) requirements.

As described above, IP service aware routers typically use flows to classify an IP packet stream, and when the packets of the packet stream match with a particular rule, an action is performed. In the canonical form, these flows appear as a <rule, action> pair, and the specific action is performed when the rule is matched. The rule is a policy used for identification/classification of packets based on the header and content of the packets including but not limited to the Layer 2 to Layer 7 headers and application data. This definition is a composite representation of routes, flows, and/or other packet classification mechanisms. There exist many variations of the basic scheme. The following discloses a few examples of them:
The rule may be complex, and specified as a set of consecutive rules with logical operations (AND, OR, XOR, etc.).
The action may be complex and a combination of multiple actions.
The actions may include next rules to be matched for cascading of services.

In service architectures, often all services are not implemented in a ‘single box’ due to technical and business reasons. In order to provide flexibility and configurability for the IP services infrastructure, the IP flows are typically routed through an ‘out-of-box’ network element that performs a specific service or a set of services.

FIG. 1 discloses an example illustrating a prior art solution. A sender 10 sends a data flow to an IP flow processing element 12. The received flow is processed using a <rule, action> pair in an action point 16. An appropriate rule to be used is determined in IP flow processing element 12 based on the received data flow. Based on the determined rule, the data flow is steered to an out-of-box service element 18 that processes/modifies the data packets in the data flow to some extent. The processed/modified data packets are sent back to IP flow processing element 12 that sends the processed/modified data packets to a receiver 14.

The traditional method of IP flow processing based on <rule, action> semantics, as described in FIG. 1, works well for out-of-box services that either leave the packet intact or slightly modify the packet. However, in this approach, it is not easily possible to implement flows where the out-of-box service actually transforms the packet (i.e. modifies the packet stream in a major way). For example, some services may even modify the protocol, e.g. aggregate multiple TCP packet streams in a single UDP-like proprietary protocol. These modified packets cannot be expected to match any pre-configured flow in the system.

Another problem in the aforementioned approach is that an observation point (the place where the rule was originally matched) and an action point (the place where the action was executed) are closely tied together. For example, let's assume that an operator uses a service aware Gateway GPRS Support Node (GGSN) with a third-party out-of-box optimizer. In this case the operator might want to perform the action of creating a charging record based on the volume of compressed data (after the out-of-box service is performed with the out-of-box optimizer). This is not possible since the rule for identifying the user needs to be matched on the original packet (before the out-of-box service is performed).

As a summary, prior art implementations work only when a packet is either left intact or modified in a minor way. The existing implementations, however, fail when the packets are e.g. completely transformed by an out-of-box network element.

### SUMMARY OF THE INVENTION

The invention discloses a solution in which a conventional <rule, action> pair is broken into a two-step process. The new processing follows e.g. <rule, optional-action, future-action-tag> out-of-box-processing <future-action-tag, egress-action> semantics. An important point is that both the “optional-action” and “egress-action” are decided on the basis of original rule. The execution of “egress-action” in only delayed till transformed packets are received back at a service-aware network element.

According to one aspect of the invention there is provided a method of processing a packet data flow in a packet data network. The method comprises determining at an observation point a rule to be applied to a packet data flow, determining at the observation point at least one egress action to be performed in at least one action point for the packet data flow based on the determined rule, assigning a future-action identifier for the packet data flow, sending data packets belonging to the packet data flow from the observation point to an external network element for processing, exchanging processed data packets between at least one external network element and the at least one action point, determining in at least one of the at least one action point, based on the assigned future-action identifier, the previously determined at least one egress action, and performing at least one of the at least one egress action in the at least one of the at least one action point.

In one embodiment of the invention, the method further comprises determining at the observation point at least one ingress action to be performed at the observation point for the packet data flow based on the determined rule and performing the at least one ingress action at the observation point.

In one embodiment of the invention, the observation point and the at least one action point refer to a single execution point.

In one embodiment of the invention, the the observation point and the at least one action point refer to separate execution points

In one embodiment of the invention, the observation point and the at least one action point comprise a single network element.

In one embodiment of the invention, the observation point and the at least one action point comprise at least two network elements.

According to another aspect of the invention there is provided a computer program for processing a packet data flow, comprising code configured to perform the following steps when executed on a data-processing device: determining at an execution point a rule to be applied to a packet data flow, determining at the execution point at least one egress action to be performed for the packet data flow based on the determined rule, assigning a future-action identifier for the packet data flow, sending data packets belonging to the packet data flow to an external network element for processing, exchanging processed data packets between the execution point and at least one external network element, determining at the execution point at least once, based on the assigned future-action identifier, the previously determined at least one egress action, and performing at least one of the at least one egress action at the execution point.

In one embodiment of the invention, the computer program is further configured to perform the following step when executed on the data-processing device: determining at least one ingress action to be performed for the packet data flow based on the determined rule, and performing the at least one ingress action.

In one embodiment of the invention, the computer program is stored on a computer readable medium.

According to another aspect of the invention there is provided a computer program for processing a packet data flow, comprising code configured to perform the following steps when executed on a data-processing device: determining a rule to be applied to a packet data flow, determining at least one egress action to be performed for the packet data flow based on the determined rule, assigning a future-action identifier for the packet data flow, and sending data packets belonging to the packet data flow to an external network element for processing.

In one embodiment of the invention, the computer program is further configured to perform the following step when executed on the data-processing device: determining at least one ingress action to be performed for the packet data flow based on the determined rule and performing the at least one ingress action.

In one embodiment of the invention, the computer program is stored on a computer readable medium.

According to another aspect of the invention there is provided a computer program for processing a packet data flow, comprising code configured to perform the following steps when executed on a data-processing device: receiving processed data packets from an external network element, determining, based on a previously assigned future-action identifier, at least one previously determined egress action, and performing the at least one previously determined egress action.

In one embodiment of the invention, the computer program is further configured to perform the following step when executed on the data-processing device: sending the received data packets after performing the at least one previously determined egress action to an external network element for further processing.

In one embodiment of the invention, the computer program is stored on a computer readable medium.

According to another aspect of the invention there is provided a network element for processing a packet data flow, comprising: an observation point configured to receive a packet data flow, to determine a rule to be applied to the packet data flow and to assign a future-action identifier for the packet data flow, to determine at least one egress action to be performed in at least one action point for the packet data flow based on the determined rule and to send data packets belonging to the packet data flow to an external network element for processing, and at least one action point configured to receive processed data packets from an external network element, to determine in at least one of the at least one action point, based on the assigned future-action identifier, the previously determined at least one egress action and to perform at least one of the at least one egress action.

In one embodiment of the invention, at least one of the at least one action point is configured to send the received data packets to an external network element for further processing.

In one embodiment of the invention, the observation point is further configured to determine at least one ingress action to be performed at the observation point for the packet data flow based on the determined rule and to perform the at least one ingress action at the observation point.

In one embodiment of the invention, the observation point and the at least one action point refer to a single execution point.

In one embodiment of the invention, the observation point and the at least one action point refer to separate execution points.

According to another aspect of the invention there is provided a network element for processing a packet data flow, comprising an observation point configured to receive a packet data flow, to determine a rule to be applied to the packet data flow and to assign a future-action identifier for the packet data flow, to determine at least one egress action to be performed in at least one action point for the packet data flow based on the determined rule and to send data packets belonging to the packet data flow to an external network element for processing.

In one embodiment of the invention, the observation point is further configured to determine at least one ingress action to be performed at the observation point for the packet data flow based on the determined rule and to perform the at least one ingress action at the observation point.

According to another aspect of the invention there is provided a network element for processing a packet data flow, comprising at least one action point configured to receive processed data packets from an external network element, to determine in at least one of the at least one action point, based on an assigned future-action identifier, the previously determined at least one egress action and to perform at least one of the at least one egress action.

In one embodiment of the invention, at least one of the at least one action point is configured to send the received data packets to an external network element for further processing.

In one embodiment of the invention, the at least one action point refers to a single execution point.

In one embodiment of the invention, the at least one action point refers to separate execution points.

According to another aspect of the invention there is provided a system of processing a packet data flow in a packet data network, comprising at least one external network element, an observation point configured to receive a packet data flow, to determine a rule to be applied to the packet data flow and to assign a future-action identifier for the packet data flow, to determine at least one egress action to be performed in at least one action point for the packet data flow based on the determined rule and to send data packets belonging to the packet data flow to an external network element for processing, and at least one action point configured to receive processed data packets from an external network element, to determine in at least one of the at least one action point, based on the assigned future-action identifier, the previously determined at least one egress action and to perform at least one of the at least one egress action.

In one embodiment of the invention, at least one of the at least one action point is configured to send the received data packets to an external network element for further processing.

In one embodiment of the invention, the observation point is further configured to determine at least one ingress action to be performed at the observation point for the packet data flow based on the determined rule and to perform the at least one ingress action.

In one embodiment of the invention, the observation point and the at least one action point refer to a single execution point.

In one embodiment of the invention, the observation point and the at least one action point refer to separate execution points.

In one embodiment of the invention, the observation point and the at least one action point comprise a single network element.

In one embodiment of the invention, the observation point and the at least one action point comprise at least two network elements.

In one embodiment of the invention, the packet data network comprises a mobile communication network.

The invention has several advantages over the prior-art solutions. The invention allows creation of IP services even with third-party out-of-box services that completely transform the packets. It also allows updating internal packet processing mechanisms/algorithms of the intermediate network elements needing upgrades to the rest of the service elements. Further, it allows the same mechanism to be used with multiple heterogeneous out-of-box network elements.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a flow diagram illustrating a prior art solution for processing data flows,

FIG. 2 is a flow diagram illustrating one embodiment of a method according to the invention,

FIG. 3 is a flow diagram illustrating one embodiment of a system according to the invention,

FIG. 4 is a flow diagram illustrating another embodiment of a system according to the invention,

FIG. 5 is a flow diagram illustrating one embodiment of an implementation concept according to the invention, and

FIG. 6 is a flow diagram illustrating another embodiment of an implementation concept according to the invention.

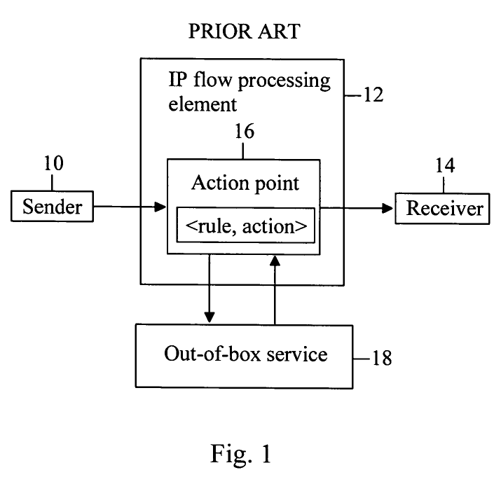

### DETAILED DESCRIPTION OF THE PREFERRED EMBODIMENTS

Reference will now be made in detail to the embodiments of the present invention, examples of which are illustrated in the accompanying drawings.

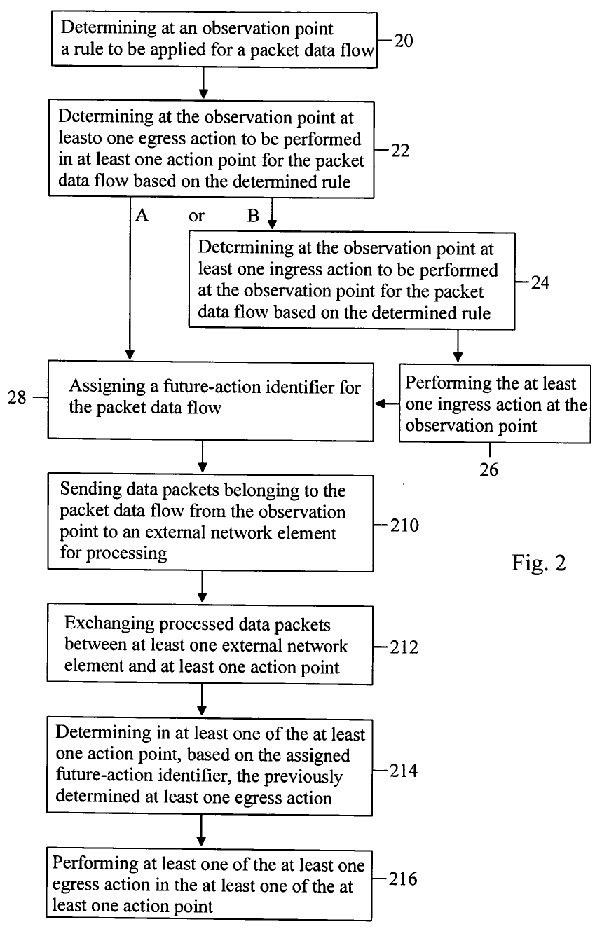

FIG. 2 illustrates an embodiment of a method according to the invention. A service aware network element, e.g. a Gateway GPRS Support Node (GGSN) of a mobile communication network receives a data flow form a data flow source. A rule to be applied to the packet data flow is determined at an observation point, step 20. Furthermore, at least one egress action to be performed in at least one action point for the packet data flow is determined at the observation point based on the determined rule, step 22. The observation point may also determine (alternative B) at least one ingress action to be performed at the observation point for the packet data flow based on the determined rule, step 24, and the at least one ingress action is performed at the observation point, step 26.

A future-action identifier is assigned for the packet data flow at the observation point, step 28. Based on the future-action identifier it is later possible to deduce which at least one egress action relates to the future-action identifier. Data packets belonging to the packet data flow are sent from the observation point to an external network element for processing, step 210. The external network element is e.g. an out-of-box service element that modifies the packet data flow in a major way.

Processed data packets are exchanged between at least one external network element and at least one action point, step 212. The term ‘exchanging’ may refer to a one-way data packet flow from an external network element to an action point. In another embodiment, an action point that receives data packets from an external network element may send them, possibly after some processing, back to the same external network element or to another external network element for further processing. An action point may also receive data packets from an out-of-box service element at a later time, not necessarily immediately after processing.

At step 214 it is determined in at least one of the at least one action point, based on the assigned future-action identifier, the previously determined at least one egress action. At step 216, at least one of the at least one egress action is performed in the at least one of the at least one action point. In other words, they may be multiple action points in which at least one egress action performed. Furthermore, there may be multiple external network element that process data packets. An external network element may send the processed data packets to the same action point from which the data packets were earlier received, or alternatively, to a different (new) action point.

The observation and action points may refer to a single execution point. In another embodiment, the observation and action points refer to separate execution points.

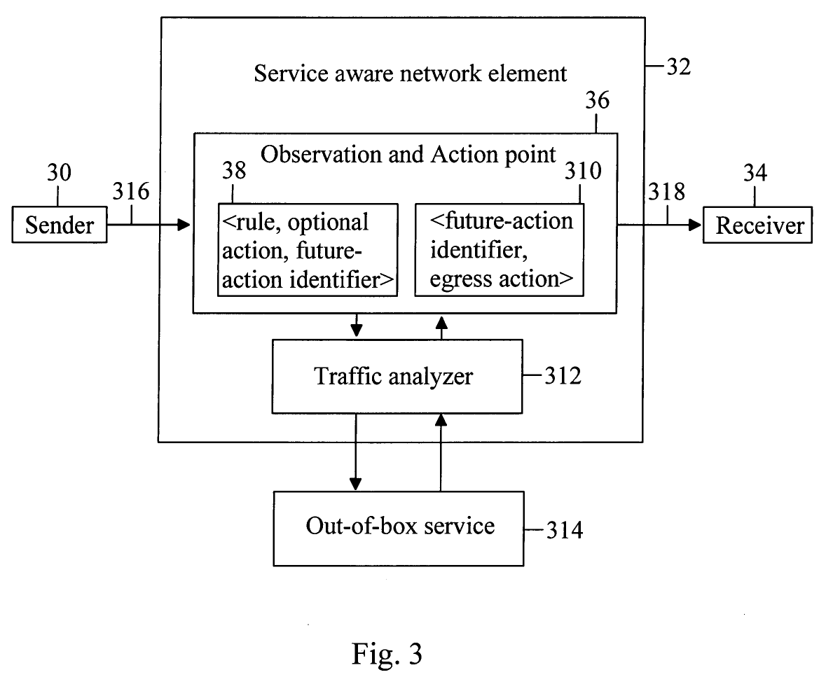

FIG. 3 describes an embodiment of a system according to the invention. The system comprises a sender 30 that sends data packets 316 to a service aware network element 32. Data packets 316 sent to service aware network element 32 refer to a data packet flow.

A general idea of the embodiment disclosed in FIG. 3 is that a conventional <rule, action> pair is broken into a two-step process. The new processing follows e.g. <rule, optional-action, future-action-tag> (38) out-of-box-processing <future-action-tag, egress-action> (310) semantics. An important point is that both the “optional-action” and “egress-action” are decided on the basis of the original rule. The execution of “egress-action” in only delayed till transformed packets are received back at service aware network element 32. The optional action may or may not be present in the execution of the rule. Examples of optional actions could include matching against access-control or security policies, or quality-of-service/traffic-management related processing.

In this embodiment a flow classification (observation) point and an action point are implemented within a single execution point 36. Observation and action point 36 determines based on flow 316 a rule to be applied to flow 316. The rule may be determined after identifying a user to which the 316 belongs. A rule may refer to a single rule or to a set of rules to be applied to flow 316. A rule e.g. may determine to which out-of-box service element the flow is directed. The observation and action point 36 could also be implemented in two separate network elements.

When a first packet of data flow 316 arrives at observation and action point 36, a decision taken at observation and action point 36 is “stored” before steering the traffic to an out-of-box service element 314. In order to identify the traffic on the way back, it is prefixed with a special future-action tag. In this embodiment, a future-action tag is used to act as a piece of information based on which the earlier taken decision can be fetched. In an actual implementation, the future-action tag may either map e.g. to a general Layer 2 identification (e.g. Virtual Local Area Network (VLAN), Frame-relay Data Link Connection Identifier (DLCI), Asynchronous Transfer Mode (ATM) Virtual Path Identifier (VPI)/Virtual Circuit Identifier (VCI), Multiprotocol Label Switching (MPLS) label, etc.) or a layer 3/4 ID such as IP address, TCP/UDP ports etc or it may be a special header/tag.

The traffic may be steered to out-of-box service element 314 via a traffic analyzer 312. Traffic analyzer takes care of steering the packets to the out-of-box service element. As an example, it could involve prepending additional packet headers or encapsulation in a tunnel (Layer-2 to Layer-7), route lookup and packet forwarding.

Out-of-box service element 314 transforms the data flow in a predetermined or dynamic manner and transmits the transformed data flow back to observation and action point 36 via traffic analyzer 312. Observation and action point 36 fetches the earlier made decisions or actions based on a future-action tag present in the traffic flow. When the actions have been determined, observation and action point 36 applies them on the transformed data packets. Finally, the transformed data packets 318 are sent to a receiver 34.

In one embodiment of FIG. 3, service aware network element 32 refers to a Gateway GPRS Support Node (GGSN) that is interfaced to a Serving GPRS Support node (SGSN) and an Internet Protocol (IP) network (sender 30). As service aware network element 32 may refer to a Gateway GPRS Support Node (GGSN), the data flow may be transmitted to receiver 34 using a Packet Data Protocol (PDP) context. In other embodiments, service aware network element 32 may refer to any other network element that is connected to an external node, that is, to an out-of-box service element. Other embodiments of FIG. 3 include the policy-based-routers, packet-classifiers, content-based switches/gateways.

It is obvious that service aware network element 32 comprises also a memory for storing rules to be applied to data flows, optional actions, future-action tags and egress actions. The memory may refer to a single memory or memory area or to a plurality memories or memory areas that may include e.g. random access memories (RAM), read-only memories (ROM) etc. The memory may also include other applications or software components that are not described in more detail and also may include a computer program (or portion thereof), which when executed on a central processing unit performs at least some of the method steps of the invention.

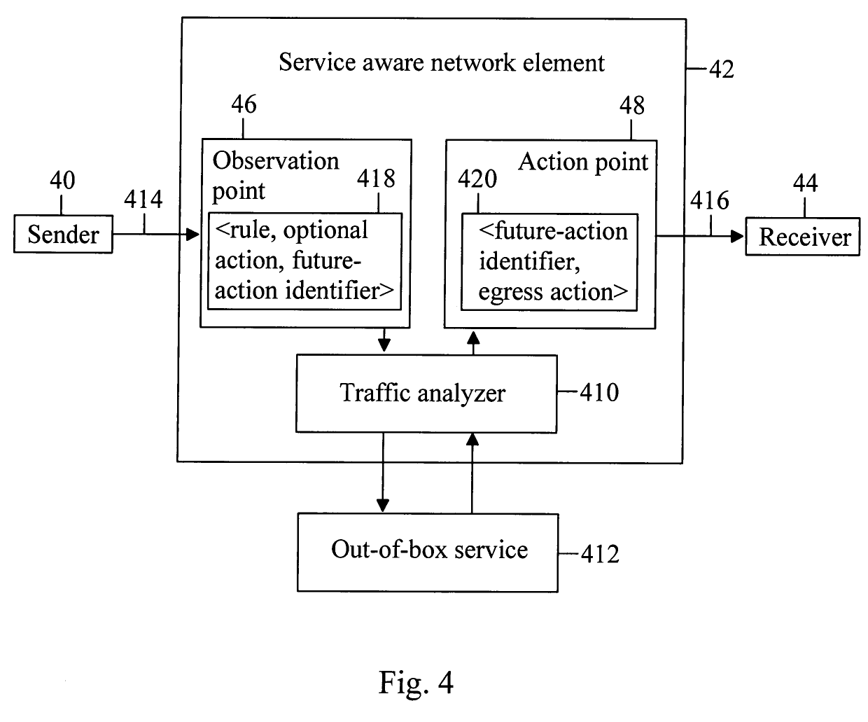

FIG. 4 describes another embodiment of a system according to the invention. The system comprises a sender 40 that sends data packets 416 to a service aware network element 42. Data packets 416 sent to service aware network element 42 refer to a data packet flow.

A general idea of the embodiment disclosed in FIG. 4 is that a conventional <rule, action> pair is broken into a two-step process. The new processing follows e.g. <rule, optional-action, future-action-tag> (418) out-of-box-processing <future-action-tag, egress-action> (420) semantics. An important point is that both the “optional-action” and “egress-action” are decided on the basis of original rule. The execution of “egress-action” in only delayed till transformed packets are received back at the service-aware network element 42.

In this embodiment a flow classification (observation) point and an action point are implemented in separate execution points. Observation point 46 determines based on flow 414 a rule to be applied to flow 414. The rule may be determined after identifying a user to which flow 414 belongs. A rule may refer to a single rule or to a set of rules to be applied to flow 414. A rule e.g. may determine to which out-of-box service element the flow is directed.

When a first packet of data flow 416 arrives at observation point 46, a decision taken at observation point 46 is “stored” before steering the traffic to an out-of-box service element 412. In order to identify the traffic on the way back, it is associated with a special future-action tag. In this embodiment, a future-action tag is used to act as a piece of information based on which the earlier taken decision can be fetched. In an actual implementation, the future-action tag may either map e.g. to a general Layer 2 identification (e.g. Virtual Local Area Network (VLAN), Frame-relay Data Link Connection Identifier (DLCI), Asynchronous Transfer Mode (ATM) Virtual Path Identifier (VPI)/Virtual Circuit Identifier (VCI), Multiprotocol Label Switching (MPLS) label, etc.) or a layer 3/4 ID such as IP address, TCP/UDP ports etc or it may be a special header/tag.

The traffic may be steered to out-of-box service element 412 via a traffic analyzer 410. Traffic analyzer takes care of steering the packets to the out-of-box service element. As an example, it could involve prepending additional packet headers or encapsulation in a tunnel (Layer-2 to Layer-7), route lookup and packet forwarding.

Out-of-box service element 412 transforms the data flow in a predetermined manner and transmits the transformed data flow back to an action point 48 via traffic analyzer 410. Action point 48 fetches the earlier made decisions or actions based on a future-action tag present in the traffic flow. When the actions have been determined, action point 48 applies them on the transformed data packets. Finally, the transformed data packets 416 are sent to a receiver 44.

In one embodiment of FIG. 4, service aware network element 42 refers to a Gateway GPRS Support Node (GGSN) that is interfaced to a Serving GPRS Support node (SGSN) and an Internet Protocol (IP) network (sender 40). As service aware network element 42 may refer to a Gateway GPRS Support Node (GGSN), the data flow may be transmitted to receiver 44 using a Packet Data Protocol (PDP) context. In other embodiments, service aware network element 42 may refer to any other network element that is connected to an external node, that is, to an out-of-box service element.

As disclosed in FIGS. 3 and 4, the two-step process can be used to separate the flow classification point or the observation point from the action point where the action is actually executed. This can be used in several scenarios such as:
1. User identification can be done based on the original packet (e.g. at observation point 46), while the user accounting can be done on a packet that is completely transformed by the out-of-box optimizer (e.g. at action point 48).
2. User identification and a packet routing decision can be taken based on user-policies (e.g. policy-based routing) based on the original packet (e.g. at observation point 46). After the packet is transformed by the out-of-box optimizer, the decision taken earlier may now be enforced.

It is obvious that service aware network element 42 comprises also a memory for storing rules to be applied to data flows, optional actions, future-action tags and egress actions. The memory may refer to a single memory or memory area or to a plurality memories or memory areas that may include e.g. random access memories (RAM), read-only memories (ROM) etc. The memory may also include other applications or software components that are not described in more detail and also may include a computer program (or portion thereof), which when executed on a central processing unit performs at least some of the method steps of the invention.

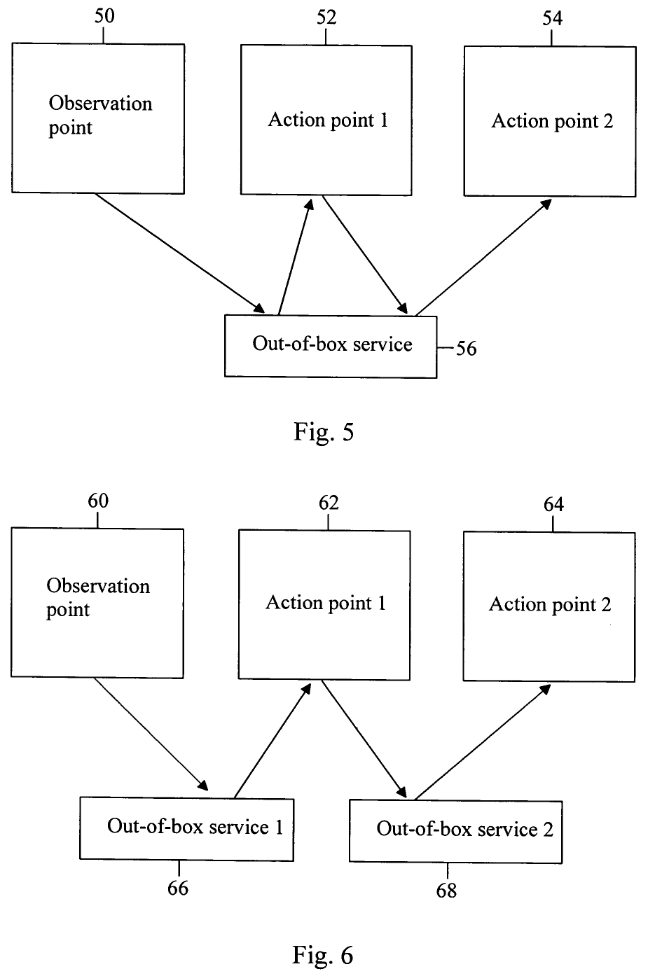

FIG. 5 is a flow diagram illustrating one embodiment of an implementation concept according to the invention. In FIGS. 3 and 4 it was disclosed that an observation point and an action point may be implemented in a single service aware network element.

FIG. 5 gives a more generalized idea how the invention may be implemented. FIG. 5 includes one observation point 50, two action points 52, 54 and one out-of-box service element 56. The idea of FIG. 5 is to show that the messaging with out-of-box service element 56 need not be limited only to a two-step process as disclosed e.g. in FIGS. 3 and 4. Out-of-box service element 56 processes data packets received from observation point 50 and sends the processed data packets to first action point 52. First action point 52 may determine, based on a previously assigned future-action identifier, the previously determined at least one egress action. Furthermore, it may perform one or more of the at least one egress action and after performing, send data packets again to out-of-box service element 56. Out-of-box service element 56 further processes data packets and sends the processed data packets to second action point 54. Again, second action point 54 may determine, based on a previously assigned future-action identifier, the previously determined at least one egress action. Furthermore, it may perform one or more of the at least one egress action.

In one embodiment of FIG. 5, action point 52 may not be able to apply any original egress action to the data packets. For example, out-of-box service element 56 may have encrypted the data packets to they cannot be modified. Therefore, in such cases there may be some default rule to apply to the data packets, e.g. a rule to send such data (exception) packets to a certain out-of-box service element for processing.

The aforementioned points 50, 52, 54 may be implemented in separate network elements. It is obvious that any other implementation solution may also be possible. For example, observation point 50 and first action point 52 may be implemented in one network element and second action point 54 in another network element. It is also possible to implement more observation or action points than is disclosed in FIG. 5.

FIG. 6 is a flow diagram illustrating one embodiment of an implementation concept according to the invention. In FIGS. 3 and 4 it was disclosed that an observation point and an action point may be implemented in a single service aware network element.

FIG. 6 gives a more generalized idea how the invention may be implemented. FIG. 6 includes one observation point 60, two action points 62, 64 and two out-of-box service elements 66, 68. The idea of FIG. 6 is to show that the messaging with out-of-box service elements 66, 68 need not be limited only to a two-step process as disclosed e.g. in FIGS. 3 and 4. Out-of-box service elements 66, 68 process data packets received from observation point 60 and first action point 62. First action point 62 may determine, based on a previously assigned future-action identifier, the previously determined at least one egress action. Furthermore, it may perform one or more of the at least one egress action and after performing, send data packets to second out-of-box service element 68. Second out-of-box service element 68 further processes data packets and sends the processed data packets to second action point 64. Again, second action point 64 may determine, based on a previously assigned future-action identifier, the previously determined at least one egress action. Furthermore, it may perform one or more of the at least one egress action.

The aforementioned points 60, 62, 64 may be implemented in separate network elements. It is obvious that any other implementation solution may also be possible. For example, observation point 60 and first action point 62 may be implemented in one network element and second action point 64 in another network element. It is also possible to implement more observation or action points than is disclosed in FIG. 6.

In one embodiment of FIG. 6, first action point 62 does not have to make decision based on original rule and future-action identifier. For example, if out-of-box service element 66 encapsulates original message in some tunnel, the decision at first action point 62 could be made only based on the packet coming from out-of-box service element 66, thus ignoring state saved (future-action identifier) from the original message.

Although it is disclosed in FIGS. 3-6 that that data packets are sent to an out-of-box service element for processing, it is obvious that a processing element does not have to be an out-of-box service element. It is only one of the possible embodiments.

The main advantage of the invention is that it allows a creation of IP services even with a third party out-of-box services that completely transform the packets.

It is obvious to a person skilled in the art that with the advancement of technology, the basic idea of the invention may be implemented in various ways. The invention and its embodiments are thus not limited to the examples described above, instead they may vary within the scope of the claims.

1. A method of processing a packet data flow in a packet data network, comprising:
determining at an observation point a rule to be applied to a packet data flow;
determining at the observation point at least one egress action to be performed in at least one action point for the packet data flow based on the determined rule;
assigning a future-action identifier for the packet data flow;
sending data packets belonging to the packet data flow from the observation point to an external network element for processing;
exchanging processed data packets between at least one external network element and the at least one action point;
determining in at least one of the at least one action point, based on the assigned future-action identifier, the previously determined at least one egress action; and
performing at least one of the at least one egress action in the at least one of the at least one action point.

2. The method according to claim 1, further comprising:
determining at the observation point at least one ingress action to be performed at the observation point for the packet data flow based on the determined rule; and
performing the at least one ingress action at the observation point.

3. The method according to claim 1, wherein the observation point and the at least one action point refer to a single execution point.

4. The method according to claim 1, wherein the observation point and the at least one action point refer to separate execution points.

5. The method according to claim 1, wherein the observation point and the at least one action point comprise a single network element.

6. The method according to claim 1, wherein the observation point and the at least one action point comprise at least two network elements.

7. A computer program for processing a packet data flow, comprising code configured to perform the following steps when executed on a data-processing device:
determining at an execution point a rule to be applied to a packet data flow;
determining at the execution point at least one egress action to be performed for the packet data flow based on the determined rule;
assigning a future-action identifier for the packet data flow;
sending data packets belonging to the packet data flow to an external network element for processing;
exchanging processed data packets between the execution point and at least one external network element;
determining at the execution point at least once, based on the assigned future-action identifier, the previously determined at least one egress action; and
performing at least one of the at least one egress action at the execution point.

8. The computer program according to claim 7, further configured to perform the following steps when executed on the data-processing device:
determining at least one ingress action to be performed for the packet data flow based on the determined rule; and
performing the at least one ingress action.

9. The computer program according to claim 7, wherein the computer program is stored on a computer readable medium.

10. A computer program for processing a packet data flow, comprising code configured to perform the following steps when executed on a data-processing device:
determining a rule to be applied to a packet data flow;
determining at least one egress action to be performed for the packet data flow based on the determined rule;
assigning a future-action identifier for the packet data flow; and
sending data packets belonging to the packet data flow to an external network element for processing.

11. The computer program according to claim 10, further configured to perform the following step when executed on the data-processing device:
determining at least one ingress action to be performed for the packet data flow based on the determined rule; and
performing the at least one ingress action.

12. The computer program according to claim 10, wherein the computer program is stored on a computer readable medium.

13. A computer program for processing a packet data flow, comprising code configured to perform the following steps when executed on a data-processing device:
receiving processed data packets from an external network element;
determining, based on a previously assigned future-action identifier, at least one previously determined egress action; and
performing the at least one previously determined egress action.

14. The computer program according to claim 13, further configured to perform the following step when executed on the data-processing device:
sending the received data packets after performing the at least one previously determined egress action to an external network element for further processing.

15. The computer program according to claim 13, wherein the computer program is stored on a computer readable medium.

16. A network element for processing a packet data flow, comprising:
an observation point configured to receive a packet data flow, to determine a rule to be applied to the packet data flow and to assign a future-action identifier for the packet data flow, to determine at least one egress action to be performed in at least one action point for the packet data flow based on the determined rule and to send data packets belonging to the packet data flow to an external network element for processing; and
at least one action point configured to receive processed data packets from an network element, to determine in at least one of the at least one action point, based on the assigned future-action identifier, the previously determined at least one egress action and to perform at least one of the at least one egress action.

17. The network element according to claim 16, wherein at least one of the at least one action point is configured to send the received data packets to an external network element for further processing.

18. The network element according to claim 16, wherein the observation point is further configured to determine at least one ingress action to be performed at the observation point for the packet data flow based on the determined rule and to perform the at least one ingress action at the observation point.

19. The network element according to claim 16, wherein the observation point and the at least one action point refer to a single execution point.

20. The network element according to claim 16, wherein the observation point and the at least one action point refer to separate execution points.

21. A network element for processing a packet data flow, comprising:
an observation point configured to receive a packet data flow, to determine a rule to be applied to the packet data flow and to assign a future-action identifier for the packet data flow, to determine at least one egress action to be performed in at least one action point for the packet data flow based on the determined rule and to send data packets belonging to the packet data flow to an external network element for processing.

22. The network element according to claim 21, wherein the observation point is further configured to determine at least one ingress action to be performed at the observation point for the packet data flow based on the determined rule and to perform the at least one ingress action at the observation point.

23. A network element for processing a packet data flow, comprising:
at least one action point configured to receive processed data packets from an external network element, to determine in at least one of the at least one action point, based on an assigned future-action identifier, the previously determined at least one egress action and to perform at least one of the at least one egress action.

24. The network element according to claim 23, wherein at least one of the at least one action point is configured to send the received data packets to an external network element for further processing.

25. The network element according to claim 23, wherein the at least one action point refers to a single execution point.

26. The network element according to claim 23, wherein the at least one action point refers to separate execution points.

27. A system of processing a packet data flow in a packet data network, comprising:
at least one external network element;
an observation point configured to receive a packet data flow, to determine a rule to be applied to the packet data flow and to assign a future-action identifier for the packet data flow, to determine at least one egress action to be performed in at least one action point for the packet data flow based on the determined rule and to send data packets belonging to the packet data flow to an external network element for processing; and
at least one action point configured to receive processed data packets from an external network element, to determine in at least one of the at least one action point, based on the assigned future-action identifier, the previously determined at least one egress action and to perform at least one of the at least one egress action.

28. The system according to claim 27, wherein at least one of the at least one action point is configured to send the received data packets to an external network element for further processing.

29. The system according to claim 27, wherein the observation point is further configured to determine at least one ingress action to be performed at the observation point for the packet data flow based on the determined rule and to perform the at least one ingress action.

30. The system according to claim 27, wherein the observation point and the at least one action point refer to a single execution point.

31. The system according to claim 27, wherein the observation point and the at least one action point refer to separate execution points.

32. The system according to claim 27, wherein the observation point and the at least one action point comprise a single network element.

33. The system according to claim 27, wherein the observation point and the at least one action point comprise at least two network elements.

34. The system according to claim 27, wherein the packet data network comprises a mobile communication network.
